(19) United States
(12) Patent Application Publication
(10) Pub. No.: US 2016/0156057 A1
(43) Pub. Date: Jun. 2, 2016

(54) ELECTROLYTE MEMBRANE

(71) Applicant: Cambridge Enterprise Limited, Cambridge (GB)

(72) Inventors: Shinbuhm LEE, Cambridge (GB); Judith Louise MACMANUS-DRISCOLL, Cambridge (GB)

(73) Assignee: Cambridge Enterprise Limited, Cambridge (GB)

(21) Appl. No.: 14/731,879

(22) Filed: Jun. 5, 2015

(30) Foreign Application Priority Data
Jun. 6, 2014 (GB) 1410092.9

(51) Int. Cl. H01M 8/1246; H01M 8/1253

(52) U.S. Cl. CPC H01M 8/1246; H01M 8/1253; H01M 2008/1293

(57) ABSTRACT

Oxygen ion conductive electrolyte membranes are disclosed for use in applications such as solid oxide fuel cells. Exemplary embodiments include an electrolyte membrane (100) comprising a composite structure of first and second oxide ceramic materials (101, 102), an oxygen ion conductive interface between the first and second materials (101, 102) extending from first to second opposing surfaces through a thickness of the membrane (100).

### TECHNICAL FIELD

The disclosure relates to oxygen ion conductive electrolyte membranes for use in applications such as solid oxide fuel cells.

### BACKGROUND

Materials capable of conducting oxygen ions are key components of devices such as solid oxide fuel cells (SOFCs), oxygen sensors and oxygen separation membranes. Solid oxide fuel cells in particular tend to require operation at elevated temperatures, partly due to the relationship between ionic conductivity and temperature. The need to operate at elevated temperatures, typically 650° C. or higher, results in difficulties with design of cells due for example to material compatibilities and the need to maintain gas tight seals and efficient operation for extended periods.

Materials commonly used for SOFC membranes include stabilised zirconia and doped ceria. These tend to be used due to their stability and compatibility with other components of the SOFC, but require temperatures normally in excess of 650° C. for efficient operation. Various alternative additions and dopants can be used, and other material systems such as lanthanum or bismuth based electrolytes have been developed. As yet, however, no material system has shown clear promise as an electrolyte for use at more practical operating temperatures. A general aim for SOFCs would be to reduce the operating temperature to around 350° C. or lower, as this would allow for much less stringent design parameters and consequently allow for SOFCs to be produced more economically. It would therefore be of great advantage to have an oxygen ion conductive membrane that could be used at lower operating temperatures while retaining a high ionic conductivity. The current most critical limitation preventing such lower temperatures from being used is ionic conductivity of the electrolyte.

### SUMMARY

In accordance with a first aspect, there is provided an electrolyte membrane comprising a composite structure of first and second oxide ceramic materials, an oxygen ion conductive interface between the first and second materials extending from first to second opposing surfaces through a thickness of the membrane.

In accordance with a second aspect, there is provided an electrolyte membrane comprising a composite structure of first and second oxide ceramic materials, one or both of the first and second oxide ceramic materials being an oxygen ion conductor, the first oxide ceramic material being in the form of a columnar structure aligned in a direction through the thickness of the membrane.

A structural and/or lattice mismatch between the first and second oxide ceramic materials results in enhanced oxygen ion conductivity through the first oxide ceramic material, i.e. along the columnar structure through the thickness of the membrane.

By providing the membrane as a composite structure, i.e. where the first and second oxide materials are different materials, the ionic conductivity of the material as a whole can be enhanced due to a mismatch between the lattice constants and/or lattice types of the two materials. The lattice mismatch results in a greater concentration of oxygen vacancies at the interface between the first and second materials. Transport of oxygen ions across the membrane can therefore be enhanced by oxygen ions travelling along the interfaces. A mismatch between the first and second oxide materials also acts to enhance oxygen ion conductivity in one of the materials, where one of the materials is already an oxygen ion conductor.

The electrolyte membrane may have an oxygen ion conductivity of greater than 0.01 Ω⁻¹ cm⁻¹ at 350° C. or 0.1 Ω⁻¹ cm⁻¹ at 500° C. between the opposing surfaces. This is substantially greater than conventional membranes based for example on yttria stabilised zirconia (YSZ) or samarium-doped ceria (SDC).

The lattice mismatch strain across the interface between the first and second oxide ceramic materials may be greater than 1%. Having such a large strain, caused by a lattice mismatch between the first and second materials, results in a substantially greater concentration of oxygen vacancies along the interface and/or a substantial enhancement of oxygen ion conductivity in one of the materials.

Either or both of the first and second oxide ceramic materials may be an oxygen ion conductor. For example, the first material may be an oxygen ion conductor while the second material is a dielectric. Alternatively, both materials may be oxygen ion conductors.

Either or both of the first and second oxide ceramic materials may have a perovskite structure, which is common for many different functional ceramic materials.

The first material may for example be composed of a stabilised zirconia, such as zirconia stabilised with a rare earth element or one or more of yttrium, hafnium, calcium, magnesium, cerium, scandium and aluminium.

The first material may alternatively be composed of ceria, typically doped with a rare earth element or one or more elements such as samarium, scandium, calcium, praseodymium and gadolinium.

The first oxide ceramic material may alternatively be composed of an oxide of lanthanum, strontium, gallium and/or magnesium, optionally doped with a further element such as cobalt.

The first oxide ceramic material may alternatively be composed of an oxide of a rare earth element such as samarium, europium, gadolinium, dysprosium or erbium.

The second material may be composed of a titanate, such as strontium titanate, barium titanate or a mixture or strontium and barium titanate. The second material may alternatively be a zirconate, such as strontium zirconate.

The first (or second) oxide ceramic material may be in the form of a columnar structure aligned in a direction through the thickness of the membrane. The columnar structure of the first (or second) oxide ceramic material may be within a matrix of the second (or first) oxide ceramic material, i.e. with each column of the first (or second) material being surrounded by the second (or first) material. Alternatively both the first and second oxide ceramic materials may be in the form of a columnar structure. The columnar structure may comprise columns of between 2 and 100 nm in diameter, which may be distributed in the matrix with a spacing of between 2 and 100 nm. A columnar structure with such dimensions allows for a high density of interfaces, thereby allowing a high overall ion flux through the film.

The membrane may be 50 nm or greater in thickness, for example between 50 nm and 5 μm in thickness.

The membrane may have an electronic conductivity (in addition to an ionic conductivity) of greater than 0.001 Ω⁻¹ cm⁻¹ at 350° C. or 0.01 Ω⁻¹ cm⁻¹ at 500° C. between the opposing surfaces. In this form, the membrane may function as a mixed conductor, i.e. capable of conducting both oxygen ions and electrons.

In accordance with a third aspect, there is provided a solid oxide fuel cell or oxygen separator comprising an oxygen ion conductive membrane according to the first or second aspect.

In accordance with a fourth aspect, there is provided a method of forming an electrolyte membrane according to the first or second aspects comprising forming the composite structure on a substrate by epitaxial growth. The composite structure will typically be formed by heteroepitaxial growth, i.e. the substrate material will be different to that of either or both of the first and second oxide ceramic materials. The composite structure may form on the substrate by self-assembly, i.e. the composite structure forms spontaneously as it is grown.

The composite structure may be formed via pulsed laser deposition, metal organic chemical vapour deposition or a physical vapour deposition method such as thermal evaporation, electron beam evaporation or sputtering.

### DETAILED DESCRIPTION

The invention is described in further detail below by way of example and with reference to the accompanying drawings, in which:

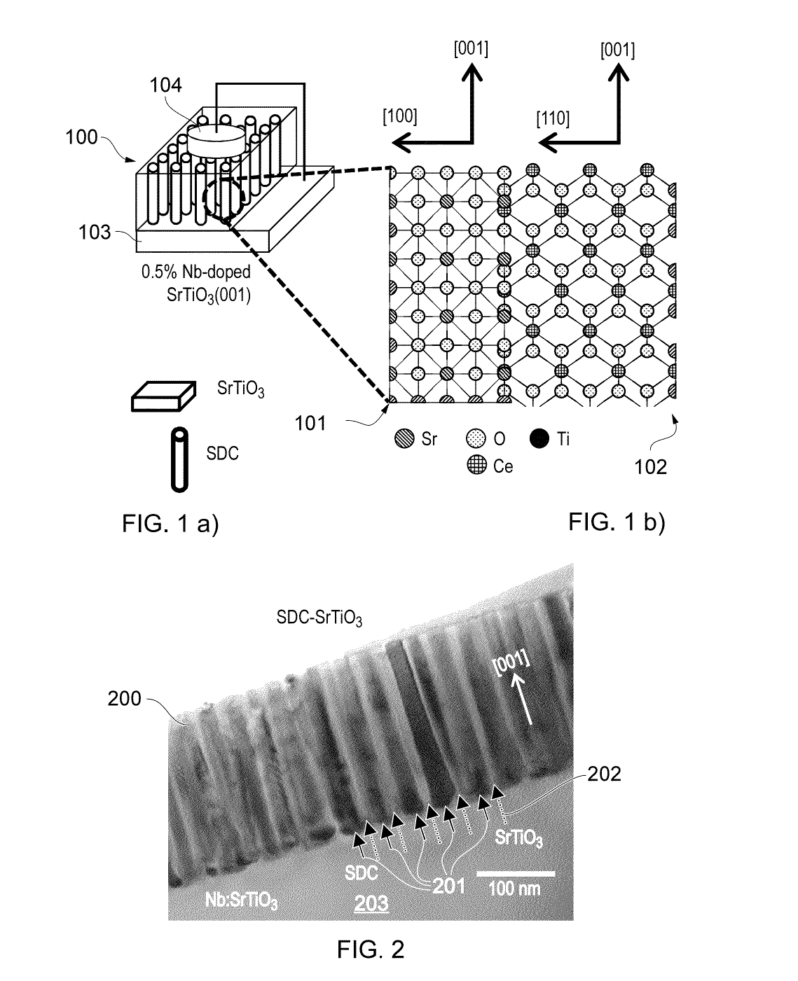

FIG. 1a is a schematic diagram of a test structure for determining conductivity of an exemplary composite electrolyte membrane;

FIG. 1b is a diagram of an interface between first and second materials in the composite membrane of FIG. 1a;

FIG. 2 is a transmission electron micrograph of a cross-section through an exemplary membrane consisting of a columnar structure of samarium doped ceria (SDC) in a strontium titanate matrix;

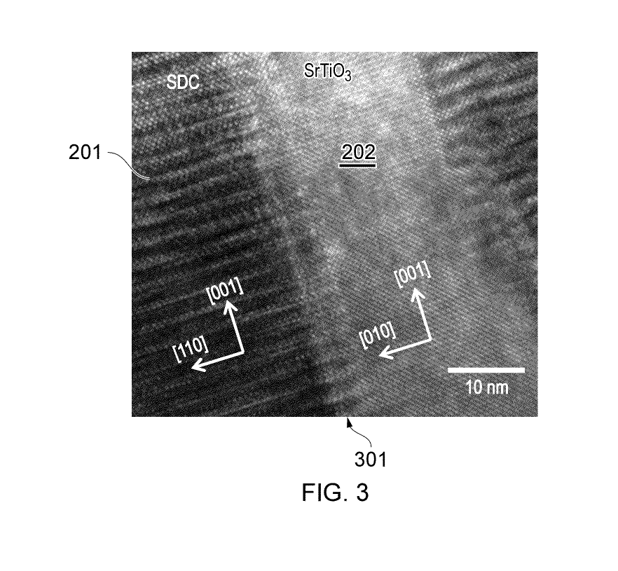

FIG. 3 is a transmission electron micrograph of an interface between SDC and SrTiO₃;

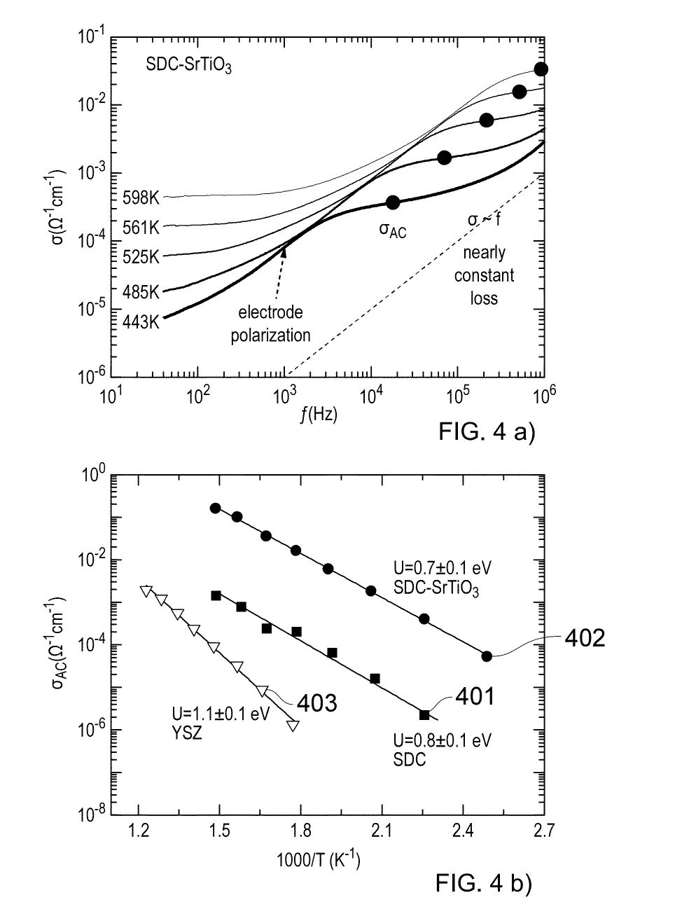

FIGS. 4a and 4b are plots of conductivity as a function of frequency (FIG. 4a) and as a function of inverse temperature (FIG. 4b) for an SDC/SrTiO₃ composite electrolyte membrane;

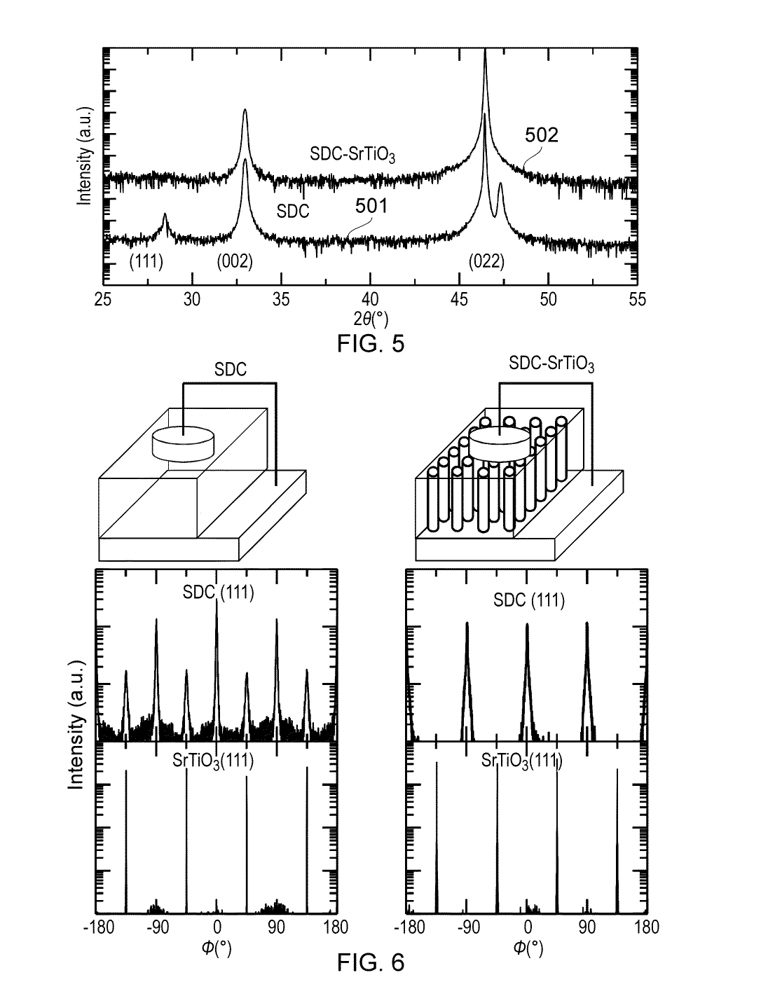

FIG. 5 is plot of x-ray diffraction traces for a composite SDC/SrTiO₃ membrane and for an SDC membrane;

FIG. 6 shows schematic diagrams of an SDC structure (left) and a composite test structure (right), with associated x-ray diffraction traces;

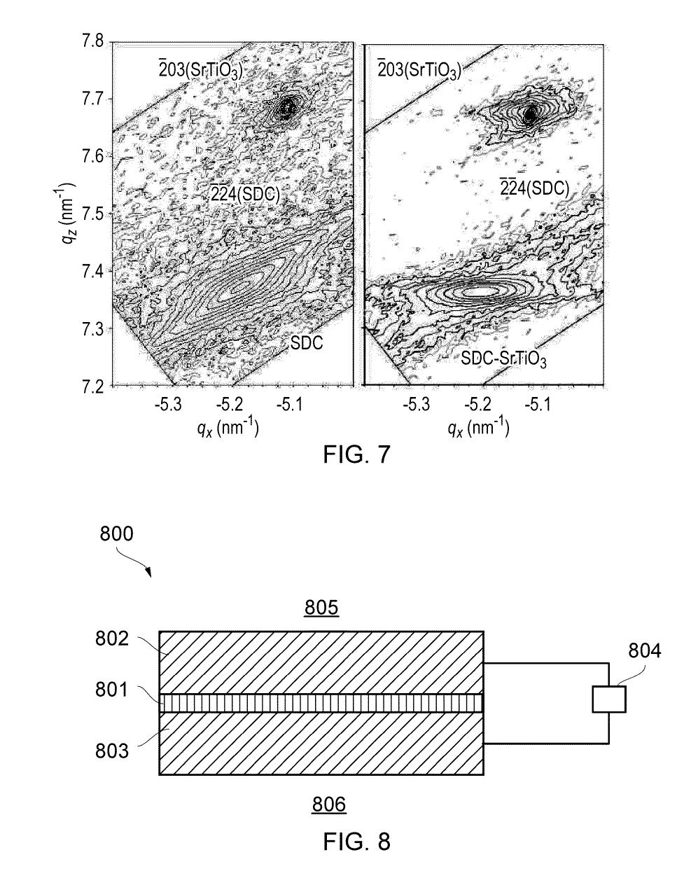

FIG. 7 shows reciprocal space maps about a (2̅03) SrTiO₃ substrate for an SDC electrolyte (left) and a composite SDC/SrTiO₃ electrolyte (right); and

FIG. 8 is a schematic diagram of a solid oxide fuel cell structure incorporating a conductive composite membrane.

Heteroepitaxial nanocomposite films were grown by pulsed laser deposition (PLD) onto single crystal substrates with a Lambda Physik KrF excimer laser (λ=248 nm) in 20 Pa flowing oxygen. A laser fluence of ˜2 Jcm⁻2 and a repetition rate of 1 Hz were used to ablate materials from composite targets onto a heated substrate (750° C.-800° C.). Although PLD was used to form the structures disclosed herein, it is expected that other deposition techniques such as metal organic chemical vapour deposition (MOCVD) or a physical vapour deposition (PVD) method such as thermal evaporation or sputtering could be used as alternatives, particularly when forming larger area films.

Either (001) SrTiO₃, or (001) Nb-doped SrTiO₃ substrates were used. For making back electrodes on (001) SrTiO₃ an intermediate epitaxial oxide layer was grown of a conducting perovskite such as SrRuO₃ (30-50 nm) The SrRuO₃ films were grown at 600° C. in an oxygen flow of 20 Pa. Film thicknesses from ˜100 nm to 2000 nm were grown and studied.

A polycrystalline sputtered metal such as platinum (Pt) was grown as a top electrode. This was done outside the PLD chamber, post-growth.

Ionic conductivities of electrolyte membranes were measured using an electrochemical impedance analyser.

FIG. 1a shows a schematic diagram of an SDC-SrTiO₃ nanoscaffold electrolyte membrane 100, with SDC columns extending through the thickness of the membrane 100 within a matrix of SrTiO₃. FIG. 1b is a schematic diagram of an interface between the SrTiO₃ phase 101 and the SDC phase 102, indicating the crystallographic growth direction, with both materials growing in the [001] direction through the thickness of the membrane. SDC-SrTiO₃ nanoscale composite electrolyte membranes of this type were grown using pulsed laser deposition. A 0.5% Nb-doped SrTiO₃ (001) single crystal was used as the substrate 103 due to its high electron conductivity and appropriate match for an anodic material of a solid oxide fuel cell. The film 100 was deposited from a polycrystalline target containing a 50:50 wt. % ratio of SDC and SrTiO₃. The overall thicknesses of films grown using this method were in the range of 200 nm to 1 μm. To compare enhancement of the cell properties, single phase SDC films were also deposited on the same substrate. A polycrystalline platinum top electrode 104 was deposited by sputtering following deposition of the membrane 100.

Although derived from mixed polycrystalline targets, the phases of SDC and SrTiO₃ self-assemble in the form of a dense nanoscale columnar structure. FIG. 2 is a transmission electron micrograph of a cross-section through the membrane 200 and substrate 203, illustrating this spontaneous phase ordering of a 230-nm-thick SDC-SrTiO₃ nanoscaffold electrolyte membrane. The dark nanocolumns 201 extend perpendicular to the substrate 203 through the entire thickness of the grown film. Since the contrast is brighter with atomic number, the darker nanocolumns 201 and the brighter surrounding matrix 202 correspond to SDC and SrTiO₃ respectively. The SDC nanocolumns can be seen to be evenly distributed with uniform sizes of around 20 nm in diameter.

A further magnified view of an interface between the SDC and SrTiO₃ phases 201, 202 is shown in FIG. 3. The interface 301 between the two phases can be seen as being sharp and well-defined.

FIG. 3a is a series of plots of ionic conductivity as a function of frequency for a 1 μm thick composite SDC-SrTiO₃ electrolyte membrane, as measured by an electrochemical impedance analyser. At higher frequencies (>10⁴ Hz), the power law dependence of the conductivity results in an almost linear frequency-dependent term, resulting in a regime with a nearly constant loss. At middle frequencies (10³ to 10⁴ Hz), the conductivity is generally independent of frequency variation. From this plateau, the ionic conductivity σ_{AC} can be determined. A further decrease in conductivity may occur in the lower frequency range (<10³ Hz) due to the presence of blocking effects by grain boundaries or electrodes. The σ_{AC} value is found to be thermally activated, so the conductivity curves shift downwards when the temperature is reduced.

FIG. 4b shows the temperature dependence of σ_{AC} in a range from around 400K (1000/400K=2.5K⁻¹) to 813 K (1000/813K=1.23K⁻). Compared with SDC films 401 (squares), the σ_{AC} of SDC-SrTiO₃ nanoscaffold electrolytes 402 (circles) is enhanced by around two orders of magnitudes. In 1 μm thick electrolyte membranes, ionic conductivity has been measured at around 0.1 Ω⁻¹ cm⁻¹ at 350° C. This is considerably lower than the 650° C. typically required to reach such high conductivity values. Indeed, this level of conductivity is believed to be the highest among various cell-architectures including YSZ electrolytes, as shown by the conductivities 403 in FIG. 4b (triangles).

To explore the possible origin of the enhanced ionic conductivity in the nanoscale composite electrolyte membranes, epitaxial stabilisation of the SDC phases using x-ray diffraction was investigated. FIG. 5 illustrates x-ray intensity as a function of angle for a 230-nm-thick SDC film 501 and for an SDC-SrTiO₃ composite membrane 502. For the SDC film, the intensity is highest for the SDC (002) reflection at 2θ=33°. Two minor peaks also appear at 28° and 47°, corresponding to SDC (111) and SDC (022) reflections, respectively. The presentation of a (111) reflection suggests some degree of polycrystalline growth for a thick film. The left two plots in FIG. 6 show φ scans of SDC (111) and SrTiO₃ (111) reflections. Four SDC (111) reflections are shifted from SrTiO₃ (111) by 45°, indicating <100>_{SDC}∥<110>_{SrTiO3}. It should be noted that four additional SDC (111) reflections also exist on SrTiO₃ (111). Epitaxial growth is also in principle possible with {110} planes of the SrTiO₃ matching the {002} planes of the SDC.

For the composite film 502, the x-ray diffraction pattern shows high intensity for the SDC (002) reflection at 2θ=33°. There are no additional peaks of intermixing phases in the range of 15° to 125°. The right two plots in FIG. 6 show φ scans of SDC (111) and SrTiO₃ (111) reflections. Four SDC (111) reflections are shifted from SrTiO₃ (111) by 45°, indicating <100>_{SDC}∥<110>_{SrTiO3}. No additional peaks exist on φ scans of SDC (111).

The epitaxial stabilization of SDC nanoscale columns can be mainly attributed to SrTiO₃-phase-induced strain in a vertical direction, i.e. through the thickness of the film. Nanoscaffold systems of this type can thereby be used for the control of strain coupling between the phases and spontaneous phase ordering in relatively thick (i.e. greater than around 100 nm) multifunctional devices. FIG. 7 shows reciprocal space maps about the (2̅03) SrTiO₃ substrate for an SDC electrolyte film (left) and an SDC-SrTiO₃ nanocomposite electrolyte film (right). In the left figure, the broad (2̅24) SDC peak in the q_{z}-axis indicates a spread of lattice parameters since the 230-nm-thick SDC film is fully relaxed. In the right figure, however, the (2̅24) SDC peaks in the q_{z}-axis are much sharper, indicating little spread of the lattice parameters and hence little or no strain relaxation through the thickness of the film. The thick epitaxial growth of <100>_{SDC}∥<110>_{SrTiO3} can thereby be achieved by SrTiO₃-phase-induced strain in a vertical direction, i.e. in the direction of growth through the thickness of the film.

Ionic conductivity has been found to depend highly on interfacial lattice misfit (which is the same as strain at the interface). The effective misfit may be defined as M(%)=Δd/d̅ where Δd is the difference and d̅ is the average of the spacing of the adjacent lattices. A coherent interface (M<1%) arises when two crystals match perfectly at the interface plane so that the two lattices are continuous across the interface. A semi-coherent interface (˜1%<M<˜25%) becomes energetically more favourable There is a general tendency for interfacial transport to become faster when interface becomes less coherent. Very high ionic conductivity has been reported in multilayer films of 1-nm-thick fluorite YSZ and 10-nm-thick perovskite SrTiO₃. With <100>_{YSZ}∥<110>_{SrTiO3}, their lateral interfaces are semi-coherent due to the lattice misfit being around 7%.

In the case of nanoscale composite electrolyte films of the type disclosed herein, the vertical interfaces of SDC and SrTiO₃ are strained due to the lattice mismatch, resulting in enhanced ionic conductivity. It is hard to assess precisely the interfacial strain because it is not necessarily certain how the lattices match at the interface. As an example, we can get close matching of lattices if we assume 2×(001)_{SrTiO3-strained} 3.918 Å=7.836 Å matches along the interface with 3×(002)_{SDC-strained} (≈3×5.427/2 Å=8.141 Å), which gives an interfacial strain level of around −3.9% or 3.7% depending on which lattice the strain is being considered to be in. Between the matching planes the vertical interfaces are structurally incompatible due to large lattice misfit and different atomic patterns of SrTiO₃ and SDC. Hence, misfit dislocations should exist at the vertical interfaces, leading to higher mobility of oxygen vacancies (Vₒ′, using the notation of Kröger and Vink). Considering the structural incompatibility at the vertical interface of the SrTiO₃ matrix and the SDC nanocolumns, it is believed that a large concentration of Vₒ′ can readily form there, which results in the higher observed ionic conductivity.

It should be noted that ionic conduction along the interfaces between the two phases is not the only mechanism for ionic conductivity through such nanocomposite films. In cases where at least one of the phases is an ionic conductor, enhanced ionic conduction through the nanocomposite film may be achieved through the conductive phase. An example is a SrZrO₃-RE₂O₃ nanoscaffold film (where RE is a rare earth element, for example selected from one or more of Sm, Eu, Gd, Dy and Er). For a vertical nanocomposite heteroepitaxial film of SrZrO₃-RE₂O₃, the ionic conductivity of the composite can be tuned and strongly enhanced using embedded, stiff, and vertical nanopillars of RE₂O₃. With increasing lattice constant of RE₂O₃ from Er₂O₃ to Sm₂O₃, the tensile strain in the SrZrO₃ will tend to increase proportionately. Accordingly, the ionic conductivity of the composite increases by an order of magnitude, and has been measured to be higher than in bulk SrZrO₃ by several orders of magnitude. Providing a selective strain in such nanocomposite films can thereby be effectively used to tune the ionic conductivity of the composite material.

From measurements of oxygen ion transport in micrometre-thick vertical nanocomposite SDC-STO films, the macroscopic ionic conductivity in nanoscaffold films was found to be higher than those in plain SDC, YSZ, and STO thick films by up to four orders of magnitude. Interfacial oxygen reduction reaction/oxygen evolution reaction (ORR/OER) processes were investigated, as well as bulk oxygen ion transport using scanning probe microscopy (SPM) techniques because of the unique nanoscaffold geometry where conduction channels can readily be probed, which is not the case for buried interfaces in standard planar films. Spatially-resolved mapping of oxygen ion transport at the nanoscale revealed that only the SDC nanocolumns have high oxygen ion conductivity, while the surrounding STO matrix showed negligible conduction. Based on these SPM results combined with complementary macroscopic measurement results, the high crystallinity of SDC nanopillars comparable to a single SDC phase is understood to be the primary origin of oxygen ion conductivity enhancement in nanoscaffold films. Namely, the surrounding STO matrix enables uniform lattices of epitaxially grown SDC nanocolumns through the whole micrometre-thick film without crystalline imperfections, leading to the measured increase in oxygen ion conductivity.

This work highlights that the crystalline quality of bulk ionic conductors is very important for ionic conductivity enhancement in oxide heterostructures, a fact which is often overlooked. In particular, the conduction in nearly single-crystalline bulk phase materials can be more dominant in oxide heterostructures composed of heavily doped ionic conductors. In addition, direct spatially-resolved mapping of oxygen ion conduction at the nanoscale can be used to verify the underlying mechanism of ionic conductivity enhancement. The vertical nanocomposite structures disclosed here allow for probing of interface and bulk regions. They also represent a simple, self-assembled system for realizing micrometre-thick fast ionic conduction channels, and are expected to be widely applicable for clean energy, multifunctional ionotronic, and novel information devices.

In conclusion, using vertical heterointerface nanocomposite films, nanoscale composite electrolyte films have been produced in which the ionic conductivity through the film is considerably higher than that of multilayer electrolytes as well as conventional electrolyte films. This enhancement can be attributed to enhanced ionic transport at incoherent interfaces that extend through the thickness of the film, as well as epitaxial stabilization of the SDC electrolyte, resulting in improved bulk ionic conduction. This enhanced ionic conductivity is expected to be of use in providing more efficient and economic solid oxide fuel cells and oxygen separators, among other applications where such ionic conductivity can be beneficial.

In the example of a solid oxide fuel cell, it is envisaged that a composite film of the type disclosed could be used as an oxygen ion conductive electrolyte membrane by interposing the film between anode and cathode layers. One of the anode and cathode layers may, for example, be formed over the grown film and the other layer formed after removal or partial removal of the substrate on which the film has been grown. The substrate may, for example, be subject to a selective etching or machining process in order to allow the surface to be exposed to a fuel or oxidising atmosphere within the fuel cell.

To obtain epitaxial growth of the nanocomposite for a practical fuel cell, two technologies that have already been developed for different applications are expected to be applicable, as both have been developed for the creation of superconducting coated conductors where highly aligned thin films are required. Both technologies start with a Ni alloy metallic substrate, with one using a highly rolled substrate to obtain grain alignment, and the other a substrate with randomly oriented grains. The technologies are generally known as RABiTs (rolling-assisted biaxially textured substrate) and IBAD (ion beam assisted deposition). In the first case, a thin film buffer oxide is coated onto a highly aligned Ni substrate using PLD, sputtering or one of the various vacuum deposition methods available. This layer acts in the same way as single crystal substrate. In the second method, a highly aligned oxide buffer layer is grown on a Ni alloy substrate using ion beam assisted deposition.

FIG. 8 illustrates schematically the key components of a fuel cell structure 800 incorporating a composite membrane 801 of the type disclosed herein. The membrane 801 is sandwiched between a cathode layer 802 and an anode layer 803, which provide electrical connections to an electrical load 804. An oxidising atmosphere is provided on the cathode side 805 of the cell 800 and a fuel atmosphere, for example hydrogen, is provided on the anode side 806 of the cell 800. Both the cathode and anode layers 802, 803 are porous or otherwise structured to allow opposing surfaces of the membrane 801 to be exposed to the respective atmospheres. Oxygen ions formed at the cathode side 805 of the membrane 801 travel by ionic conduction through the membrane 801 and combine with fuel on the anode side of the membrane 801, completing the electrical circuit. Typical materials used for cathode and anode layers with conventional electrolytes such as YSZ are a Ni—ZrO₂ cermet for the anode layer and a doped LaMnO₃ for the cathode layer.

Other embodiments are intentionally within the scope of the invention as defined by the appended claims.

1. An electrolyte membrane comprising a composite structure of first and second oxide ceramic materials, an oxygen ion conductive interface between the first and second materials extending from first to second opposing surfaces through a thickness of the membrane.

2. The electrolyte membrane of claim 1 wherein the membrane has an oxygen ion conductivity of greater than 0.01 Ω⁻¹ cm⁻¹ at 350° C. or 0.1 Ω⁻¹ cm⁻¹ at 500° C. between the opposing surfaces.

3. The electrolyte membrane of claim 1 wherein a strain between the first and second oxide ceramic materials across the interface is greater than 1%.

4. The electrolyte membrane of claim 1 wherein either or both of the first and second oxide ceramic materials is an oxygen ion conductor.

5. The electrolyte membrane of claim 1 wherein either or both of the first and second oxide ceramic materials has a perovskite structure.

6. The electrolyte membrane of claim 1 wherein the first oxide ceramic material is composed of a stabilised zirconia.

7. The electrolyte membrane of claim 6 wherein the first oxide ceramic material is composed of zirconia stabilised with a rare earth element.

8. The electrolyte membrane of claim 6 wherein the first oxide ceramic material is composed of zirconia stabilised with one or more of yttrium, hafnium, calcium, magnesium, cerium, scandium and aluminium.

9. The electrolyte membrane of claim 1 wherein the first oxide ceramic material is composed of ceria.

10. The electrolyte membrane of claim 9 wherein the first oxide ceramic material is doped with a rare earth element.

11. The electrolyte membrane of claim 9 wherein the first oxide ceramic material is doped with one or more of samarium, calcium, praseodymium and gadolinium.

12. The electrolyte membrane of claim 1 wherein the first oxide ceramic material is composed of an oxide of lanthanum, strontium, gallium and/or magnesium, optionally doped with a further element such as cobalt.

13. The electrolyte material of claim 1 wherein the first oxide ceramic material is composed of an oxide of a rare earth element.

14. The electrolyte material of claim 13 wherein the rare earth element is selected from one or more of samarium, europium, gadolinium, dysprosium and erbium.

15. The electrolyte membrane of claim 1 wherein the second oxide ceramic material is composed of a titanate such as barium and/or strontium titanate.

16. The electrolyte membrane of claim 1 wherein the second oxide ceramic material is strontium zirconate.

17. The electrolyte membrane of claim 1 wherein the first or second oxide ceramic material is in the form of a columnar structure aligned in a direction through the thickness of the membrane.

18. The electrolyte membrane of claim 17 wherein the columnar structure of the first oxide ceramic material is within a matrix of the second oxide ceramic material.

19. The electrolyte membrane of claim 17 wherein the columnar structure of the second oxide ceramic material is within a matrix of the first oxide ceramic material.

20. The electrolyte membrane of claim 17 wherein the columnar structure comprises columns of between 2 and 100 nm in diameter.

21. The electrolyte membrane of claim 17 wherein the columns are distributed across the membrane with a spacing of between 2 and 100 nm.

22. The electrolyte membrane of claim 1 wherein the membrane is 50 nm or greater in thickness.

23. The electrolyte membrane of claim 22 wherein the membrane is between 50 nm and 5 μm in thickness.

24. The electrolyte membrane of claim 1 wherein the membrane has an electronic conductivity of greater than 0.001 Ω⁻¹ cm⁻¹ at 350° C. or 0.01 Ω⁻¹ cm⁻¹ at 500° C. between the opposing surfaces.

25. An electrolyte membrane comprising a composite structure of first and second oxide ceramic materials, one or both of the first and second oxide ceramic materials being an oxygen ion conductor, the first oxide ceramic material being in the form of a columnar structure aligned in a direction through the thickness of the membrane.

26. The electrolyte membrane of claim 25 wherein a structural and/or lattice mismatch between the first and second oxide ceramic materials results in enhanced oxygen ion conductivity through the first oxide ceramic material.

27. A solid oxide fuel cell or oxygen separator comprising an electrolyte membrane according to claim 1.

28. A method of forming an electrolyte membrane according to claim 1 comprising forming the composite structure on a substrate by epitaxial growth.

29. The method of claim 28 wherein the composite structure forms on the substrate by self assembly.

30. The method of claim 28 wherein the composite structure is formed via pulsed laser deposition, metal organic chemical vapour deposition or a physical vapour deposition method such as thermal evaporation or sputtering.
